(19) United States
(12) Patent Application Publication
(10) Pub. No.: US 2025/0148305 A1
(43) Pub. Date: May 8, 2025

(54) PERSONALIZED THRILL RIDE RECOMMENDER

(71) Applicant: INTERNATIONAL BUSINESS MACHINES CORPORATION, Armonk, NY (US)

(72) Inventors: Partho Ghosh, Kolkata (IN); Shailendra Moyal, Pune (IN); Sarbajit K. Rakshit, Kolkata (IN); Saraswathi Sailaja Perumalla, Visakhapatnam (IN)

(21) Appl. No.: 18/387,164

(22) Filed: Nov. 6, 2023

(51) Int. Cl. G06N 5/022

(52) U.S. Cl. CPC G06N 5/022

(57) ABSTRACT

Embodiments receive ride data, user data which comprises user information and other user data, and crowd-sourced historical data, train a machine learning model using a knowledge corpus which includes the ride data, the user data, and the crowd-sourced historical data, and dynamically adjust at least one ride recommendation based on the trained machine learning model.

### BACKGROUND

Aspects of the present invention relate generally to a personalized thrill ride recommender and, more particularly, to dynamically providing personalized thrill ride recommendations based on ride data and user data.

Amusement parks include a geospatial region consisting of a plurality of land rides such as roller coasters, water rides such as ferry rides, water slides, and artificial sea waves, games, and other entertainment events. Amusement parks create a high-energy environment through action filled experiences and thrills.

### SUMMARY

In a first aspect of the invention, there is a computer-implemented method including: receiving, by a processor set, ride data, user data which comprises user information and other user data, and crowd-sourced historical data; training, by the processor set, a machine learning model using a knowledge corpus which includes the ride data, the user data, and the crowd-sourced historical data; and dynamically adjusting, by the processor set, at least one recommendation based on the trained machine learning model.

In another aspect of the invention, there is a computer program product including one or more computer readable storage media having program instructions collectively stored on the one or more computer readable storage media. The program instructions are executable to: receive crowd-sourced historical data; generate community data from the received crowd-sourced historical data; cluster the generated community data using a k-means clustering algorithm of a machine learning model; and send the clustered community data to a user device of a user.

In another aspect of the invention, there is a system including a processor set, one or more computer readable storage media, and program instructions collectively stored on the one or more computer readable storage media. The program instructions are executable to: receive ride data, user data which comprises user information and other user data, and crowd-sourced historical data; train a machine learning model using a knowledge corpus which includes the ride data, the user data, and the crowd-sourced historical data; and dynamically adjust at least one recommendation based on the trained machine learning model. The machine learning model is trained using the knowledge corpus using a reinforcement learning algorithm.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of another exemplary method in accordance with aspects of the present invention.

FIG. 5 shows a flowchart of another exemplary method in accordance with aspects of the present invention.

FIG. 6 shows a flowchart of another exemplary method in accordance with aspects of the present invention.

### DETAILED DESCRIPTION

Aspects of the present invention relate generally to a personalized thrill ride recommender and, more particularly, to dynamically providing personalized thrill ride recommendations based on ride data and user data. Embodiments of the present invention recommend thrill rides based on the ride data and user data including medical conditions and user data and provide suggestions for riding the thrill rides, such as a recommended seat, ergonomics for the recommended seat, a wait time between rides, food choices, etc. Embodiments of the present invention simulate user data, such as blood pressure, consciousness, dizziness, and oxygen levels based on data from wearable devices for a user or a group of users and provide recommendations for thrill rides based on the simulated user data. Embodiments of the present invention recommend which part of a ride a user should be sitting in and a sitting position based on the user data of the user. Embodiments of the present invention generate a thrill experience score and a feedback score based on crowd-sourced from different user profiles.

Embodiments of the present invention recommend an appropriate sitting fitment of a seat in a ride based on user data of a user, such as weight, height, seat ergonomics, etc., by correlating the appropriate sitting fitment with security and ergonomic features, such as a capacity of a seat belt, a strength of the seat belt during the ride, chair fitment to the user. Embodiments of the present invention determine a mismatch of body metrics, a height profile, and health conditions of the user to a thrill ride including ergonomic discrepancies of the seat to a profile of the user. For example, embodiments of the present invention determine that a user has a height which does not match a seating requirement to ride the thrill ride. Embodiments of the present invention provide suggestions to the user, including a different time slot for riding a ride, a time frame for riding the ride, a resting time between rides, a time of day for riding the ride, and a sequence for going on different rides. For example, embodiments of the present invention suggest a required resting time between rides of the user based on the profile of the user to help relieve symptoms of motion sickness that occurs between the rides. Embodiments of the present invention provides a route recommendation that suggests the rides and facilities that should be visited and the order that the rides and facilities should be visited.

Embodiments of the present invention provide a digital twin of an amusement park to assist users in simulating a sequence of rides. In an example, the user simulates a sequence of rides in a digital twin of the amusement park through one of an augmented reality device and a geospatial based device. In particular, the user simulates the sequence of rides in the digital twin of the amusement park to determine unsafe regions for the user to enter the ride (e.g., areas when entering the ride that the user may be hit by an object) or unsafe regions for the user to move towards during the ride (e.g., how far the user should go into an artificial sea). Embodiments of the present invention create a knowledge corpus of phobias (e.g., a user scared of heights, a user scared of free falls, a user scared of water, a user scared of motion sickness, etc.) and health conditions from smart wearable user devices. Embodiments of the present invention also generate a knowledge corpus of crowd-sourced historical data (e.g., phobias) of people entering into the amusement park that would help to suggest appropriate rides based on the phobias of a specific user. Embodiments of the present invention suggest a personalized package of events and rides during an amusement park visit that is based on a historical medical profile of a user and demographics (e.g., age, weight, etc.) of the user.

Embodiments of the present invention suggest a user to avoid certain rides based on a thrill experience score, feedback score, a thrill level, etc. Embodiments of the present invention also adjust future recommendations by incorporating previous historical feedback including multi-point data elements gathered by previous ride takers in the amusement park. Embodiments of the present invention recommend precautionary measures (e.g., wearing a life jacket, anti-vomit and nausea medication, etc.) that correlate a contextual and/or situational awareness of a health of a user, eating habits of the user, type of food consumers by the user, clothing of the user, environmental conditions (e.g., rainy) of the amusement park before and after the ride. Embodiments of the present invention also recommend preventative measures (e.g., no land rides after lunch) that correlate a contextual and/or situational awareness of a health of a user, cating habits of the user, type of food consumers by the user, clothing of the user, environmental conditions (e.g., rainy) of the amusement park before and after the ride. As an example, embodiments of the present invention suggest a type of clothing garment to be worn by a user to prevent injury from the clothing garment being stuck in a ride. Embodiments of the present invention dynamically generate community data in which users of the community are correlated by different factors such as type of amusement park rides, genre of amusement park rides, thrill rides, water events, sport events, environmental factors, user profiling, health profiles, and user motives.

Embodiments of the present invention utilize ride data and user data to provide personalized thrill ride recommendations. In contrast, conventional systems don't provide recommendations for rides in an amusement park, which can cause slip and fall accidents, incorrect seat choice, incorrect posture, unsafe foods consumed before and after a ride, not enough resting gaps between rides, dizzy or nauseated symptoms on rides, bad health for taking a ride, and a situation where a user is unfit to take a ride based on user data, such as body, age, weight, etc. In particular, as conventional systems do not incorporate ride data or user data, conventional systems are not able to provide recommendations for improving a user experience at an amusement park. In contrast, embodiments of the present invention utilize the ride data and the user data to provide personalized recommendations to enhance a user experience during a visit to an amusement park.

Embodiments of the present invention include a highly computationally efficient system, method, and computer program product for providing personalized recommendations for thrill rides. Accordingly, implementations of the present invention provide an improvement (i.e., technical solution) to a problem arising in the technical field of passengers suffering from injury or medical conditions at an amusement park. In particular, embodiments of the present invention utilize the ride data and user data to provide personalized thrill ride recommendation. Also, embodiments of the present invention may not be performed in the human mind because aspects of the present invention comprise using a machine learning (ML) model to adjust future recommendations based on historical crowd-sourced data from users of the amusement park and provide community data which clusters members of the community by common factors using the ML model. Further, these implementations of the present invention improve the functioning of the computer by utilizing a ride data and user data to provide personalized thrill ride recommendations.

Implementations of the present invention are necessarily rooted in computer technology. For example, the steps of adjusting future recommendations based on historical crowd-sourced data from users of the amusement park using a machine learning (ML) model and providing community data which clusters members of the community by common factors using the ML model are computer-based and cannot be performed in the human mind. Training and using an ML model are, by definition, performed by a computer and cannot practically be performed in the human mind (or with pen and paper) due to the complexity and massive amounts of calculations involved. For example, the ML model in embodiments of the present invention may perform an iterative process of receiving historical crowd-sourced dates from users and analyzing past actions of the users to provide recommendations for rides. In particular, the ML model in embodiments of the present invention performs a large amount of processing of current and past data and modeling of parameters to train the ML model such that the ML model generates an output in real time (or near real time). Given the scale and complexity of processing current and past data and modeling of parameters, it is simply not possible for the human mind, or for a person using pen and paper, to perform the number of calculations involved in training and/or using the ML model.

Aspects of the present invention include a method, system, and computer program product for recommending thrill rides. For example, a computer-implemented method includes: simulating user data including blood pressure, consciousness, dizziness, and oxygen levels, based on data from wearable devices for a user; and providing recommendations for thrill rides based on the simulated user data. In particular, the recommendations for thrill rides include a ride recommender, a sequence of rides, community data of historical crowd-source data, ergonomic fitments of a plurality of seats in a ride, and precautions before going on a ride.

It should be understood that, to the extent implementations of the present invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as thrill ride recommender code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

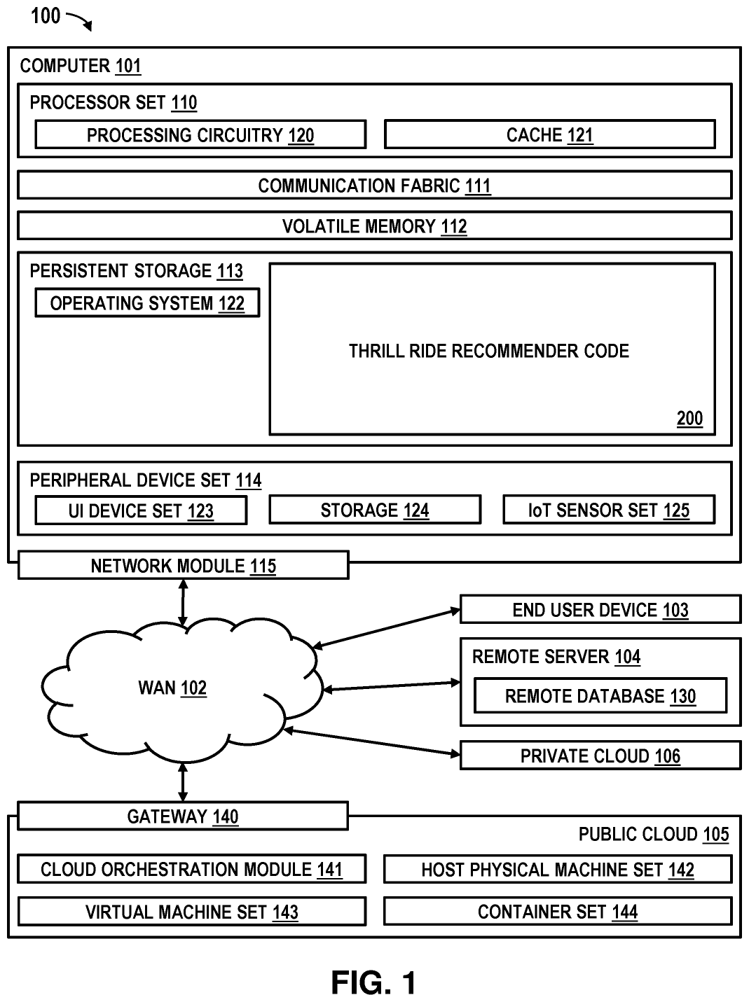

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

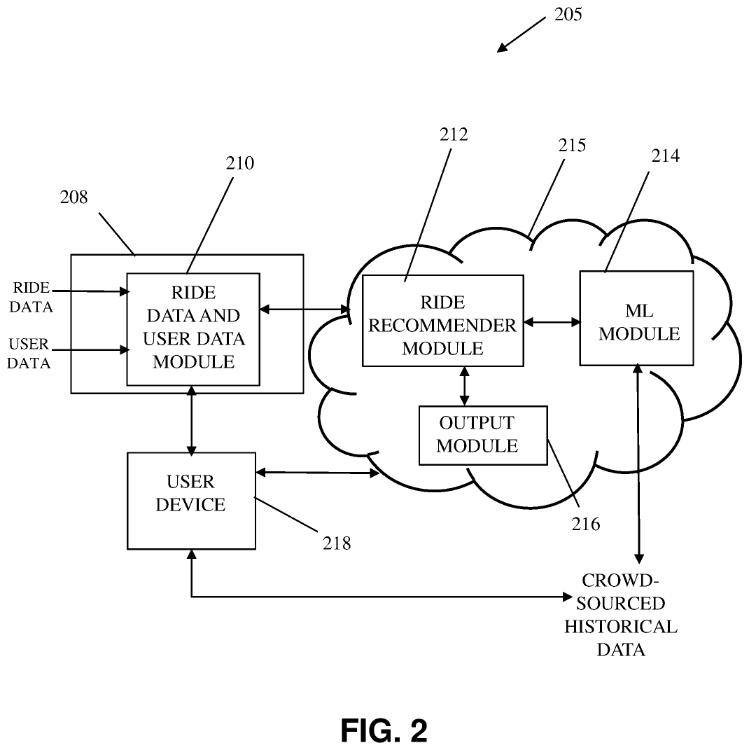

FIG. 2 shows a block diagram of an exemplary environment 205 in accordance with aspects of the present invention. In embodiments, the environment 205 includes a ride recommender server 208, which may comprise one or more instances of the computer 101 of FIG. 1. In other examples, the ride recommender server 208 comprises one or more virtual machines or one or more containers running on one or more instances of the computer 101 of FIG. 1.

In embodiments, the ride recommender server 208 of FIG. 2 comprises a ride data and user data module 210, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. ride recommender server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the present invention, the ride data and user data module 210 and a user device 218 communicate with a cloud-based system 215 comprising a ride recommender module 212, a machine learning (ML) module 214, and an output module 216. In embodiments, the ride data and user data module 210 communicates with the ride recommender module 212 through the cloud-based system 215. In other embodiments, the user device 218 communicates with the ML module 214 and the output module 216 through the cloud-based system 215. However, embodiments are not limited to this example, and the ride data and user data module 210, the ride recommender module 212, the ML module 214, the output module 216, and the user device 218 may all be included in the cloud-based system 215.

In FIG. 2, and in accordance with aspects of the present invention, the ride data and user data module 210 receives ride data and user data. In embodiments, the ride data includes information about a type of ride (e.g., land ride, water ride, water slide, roller coaster, sea waves, etc.), how the ride is moving (e.g., merry-go-round, up and down, etc.), the seat arrangements and ergonomics of the ride (e.g., locking of seat belts, capacity and strength of seat belts, chair fitment, breathing difficult when the seat belt is locked and engaged, etc.), the availability of the ride (e.g., both time availability, current capacity, etc.), restrictions of the ride (e.g., height restrictions of the ride), and precautions of the ride (e.g., life jackets). In embodiments, the user data includes user information such as blood pressure, consciousness, ergonomic preferences, dizziness, oxygen levels, height, weight, age, and health and medical conditions (e.g., height phobias, motion sickness, nausea, etc.) and other user data (e.g., medications, eating habits and food consumed, current clothing, etc.). For example, the user information and other user data may be provided by a wearable device on the user, a smartphone of the user, a smartwatch of the user, a sensor attached to the user, etc. In addition, the user information and other user data may also be provided from the user device 218 (which can also be a smartwatch, smartphone, wearable device, sensor, etc.) In further embodiments, the user information may comprise biometric information.

In FIG. 2, and in accordance with aspects of the present invention, the ride data and user data module 210 monitors the ride data and the user data for changes and adjustments. In an example, the ride data and user data module 210 simulates a sitting arrangement of a ride based on changes in the user information of the user data. The ride data and user data module 210 also monitors the user information of the user data both during and after a ride. In another example, the ride data and user data module 210 generates a digital twin of the amusement park to allow users to simulate a sequence of rides within an augmented reality (AR) application of the user device 218. In an example, the ride data and user data module 210 generates the digital twin of the amusement park to allow users to simulate a sequence of rides within a geospatial application of the user device 218. The ride data and user data module 210 also receives crowd-sourced historical data through the user device 218 and generates a thrill experience score and feedback score from the crowd-sourced historical data. In particular, the thrill experience score is based on a user describing how thrilling a ride is on a scale from zero to ten. The feedback score is based on the user describing an overall experience of the ride on a scale from zero to ten. The ride data and user data module 210 then sends the ride data, the user data including the user information both during the ride and after the ride and other user data, the simulated sitting arrangement, the digital twin of the amusement park, the thrill experience score, and the feedback score to the ride recommender module 212.

In FIG. 2, and in accordance with aspects of the present invention, the ML module 214 includes a machine learning model and a knowledge corpus for training the machine learning model. In particular, the knowledge corpus includes the user information, other user data, the ride data, and crowd-sourced historical data from the ride recommender module 212. In particular, the knowledge corpus includes a plurality of phobias (e.g., height phobia, free fall phobia, motion sickness phobia, etc.) which are received from the user information, other user data, and crowd-sourced historical data. The machine learning model is iteratively trained using the knowledge corpus as the user information, other user data, the ride data, and crowd-sourced historical data are received and updated from the ride recommender module 212. Then, the machine learning model of the ML module 214 dynamically adjusts future recommendations based on the knowledge corpus in real-time and sends the dynamically adjusted future recommendations to the ride recommender 212 for adjusting the future recommendations provided by the ride recommender 212. The machine learning model is iteratively trained by the knowledge corpus using a reinforcement learning algorithm.

In FIG. 2, and in accordance with aspects of the present invention, the ML module 214 generates community data from crowd-sourced historical data from the user device 218. In particular, the community data includes information from a plurality users of a community which are correlated by different factors such as type of amusement park rides, genre of amusement park rides, thrill rides, water events, sport events, environmental factors, user profiling, health profiles, and user motives. In addition, the ML module 214 clusters the community data by common factors using a k-means clustering algorithm of the machine learning model. Further, the ML module 214 sends the clustered community data to the user device 218 through the cloud-based system 215. In embodiments, the user is able to gain insight and knowledge about the rides and events of the amusement park through the user device 218.

In FIG. 2, and in accordance with aspects of the present invention, the ride recommender module 212 is configured to correlate a contextual and situational awareness of a health of a user, eating habits of the user, food consumed by the user, clothing of the user, environmental conditions (e.g., rainy) before the user takes the ride. Further, the ride recommender module 212 is also configured to correlate a contextual and situational awareness of a health of a user, cating habits of the user, food consumed by the user, clothing of the user, environmental conditions (e.g., rainy) after the user takes the ride. In particular, the ride recommender module 212 recommends appropriate thrill rides to the user based on the user information both during the ride and after the ride. The ride recommender module 212 recommends which part of a ride the user should be sitting in based on ergonomic preferences in the user information. The ride recommender module 212 also recommends sitting positions and sitting fitments for the user within the ride which correspond with at least one of the seat arrangements and ergonomics of the rides (e.g., locking of seat belts, capacity and strength of seat belts, chair fitment) and ergonomic preferences in the user information. Further, the ride recommender module 212 also either recommends the user take a ride or recommends the user not take the ride based on the seat arrangements and ergonomics of the rides (e.g., locking of seat belts, capacity and strength of seat belts, chair fitment) and ergonomic preferences in the user information. The ride recommender module 212 recommends the user not take the ride based on a mismatch of the user information of the user (e.g., height) and the restrictions of the ride (e.g., height restrictions of the ride). The ride recommender module 212 recommends the user not take the ride based on a mismatch between the ride data (e.g., how the ride is moving, the seat arrangements and ergonomics of the ride, etc.) and one of health and medical conditions in the user information (e.g., nausea).

In FIG. 2, and in accordance with aspects of the present invention, the ride recommender module 212 suggests appropriate rides based on the health and medical conditions (e.g., height phobia) in the user information. The ride recommender module 212 also recommends the user not take a ride based on a mismatch between the ride data (e.g., how the ride is moving, the seat arrangements and ergonomics of the ride, etc.) and one of health and medical conditions in the user information (e.g., height phobia). The ride recommender module 212 also recommends precautions of a ride (e.g., life jacket, anti-vomit medication, etc.) based on a ride data (e.g., how the ride is moving) of the ride. The ride recommender module 212 also recommends the user not take land rides based on other user data (e.g., after the user has recently eaten lunch). The ride recommender module 212 also recommends a type of clothing to be worn during the ride to prevent injury from the current clothing of the user getting stuck in the ride based on other user data (e.g., current clothing worn by the user).

In FIG. 2, and in accordance with aspects of the present invention, the ride recommender module 212 suggests at least one of a different time slot, a time frame, and a time of day for taking the ride based on the availability of the ride (e.g., time availability, current capacity, etc.) The ride recommender module 212 also suggests a sequence of rides based on the availability of rides (e.g., time availability, current capacity, etc.) The ride recommender module 212 also recommends a required resting time between rides to allow the user to relieve motion sickness based on the health and medical conditions in the user information. The ride recommender module 212 also generates a plurality of first flags which correspond with a plurality of first unsafe regions for a user to enter in during a ride based on the ride data. The ride recommender module 212 also generates a plurality of second flags which correspond with a plurality of second unsafe regions for a user who is walking through an amusement park.

In FIG. 2, and in accordance with aspects of the present invention, the ride recommender module 212 recommends a personalized event and ride package which includes at least one ride for a user to take in an amusement park based on the user information and other use data the user provides during an initial enrollment of the user with the amusement park. The ride recommender module 212 recommends a ride based on the thrill experience score, the feedback score, and a number of iterations the ride has been taken from the crowd-sourced historical data. Also, the ride recommender module 212 suggests that the user not take the ride based on the thrill experience score, the feedback score, and a number of iterations the ride has been taken from the crowd-sourced historical data.

In FIG. 2, and in accordance with aspects of the present invention, the ride recommender module 212 sends the recommendations and suggestions to the output module 216. In embodiments, the output module 216 is a display in the amusement park which is used by amusement park employees to set up, maintain, and supervise the rides and events of the amusement parks for users. In other embodiments, the ride recommender module 212 sends the recommendations and suggestions to the user device 218 through the cloud-based system 215. The user device 218 may be easily accessible by the user (e.g., the user device 218 can be a smartphone) as the user moves throughout the rides and events of the amusement park.

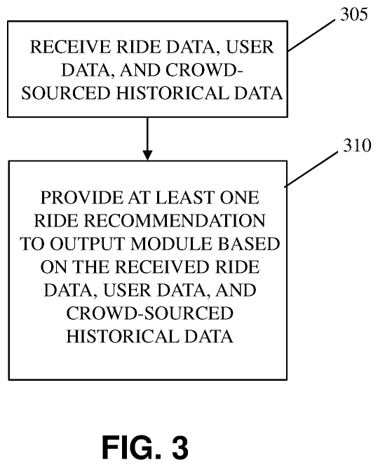

FIG. 3 shows a flowchart of an exemplary method in accordance with aspects of the present invention. Steps of the method may be carried out in the environment of FIG. 2 and are described with reference to elements depicted in FIG. 2.

In embodiments, at step 305, the system receives, at the ride data and user data module 210, ride data, user data, and crowd-sourced historical data. In embodiments and as described with FIG. 2, the ride data includes information about a type of ride, how the ride is moving, the seat arrangements and ergonomics of the ride, the availability of the ride, restrictions of the ride, and precautions of the ride and the user data includes user information and other user data. In further embodiments, the ride data and user data module 210 sends the ride data, the user data, and the crowd-sourced historical data to a ride recommender module 212.

In embodiments, at step 310, the system provides, at the ride recommender module 212, at least one ride recommendation to the output module 216 based on the received ride data, the user data, and the crowd-sourced historical data. In embodiments and as described with FIG. 2, the output module 216 is a display in the amusement park which is used by amusement park employees to set up, maintain, and supervise the rides and events of the amusement parks for users.

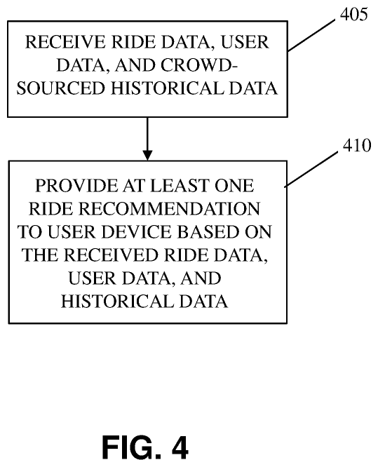

FIG. 4 shows a flowchart of another exemplary method in accordance with aspects of the present invention. Steps of the method may be carried out in the environment of FIG. 2 and are described with reference to elements depicted in FIG. 2.

In embodiments, at step 405, the system receives, at the ride data and user data module 210, ride data, user data, and crowd-sourced historical data. In embodiments and as described with FIG. 2, the ride data includes information about a type of ride, how the ride is moving, the seat arrangements and ergonomics of the ride, the availability of the ride, restrictions of the ride, and precautions of the ride and the user data includes user information and other user data. In further embodiments, the ride data and user data module 210 sends the ride data, the user data, and the crowd-sourced historical data to a ride recommender module 212.

In embodiments, at step 410, the system provides, at the ride recommender module 212, at least one ride recommendation to the user device 218 based on the received ride data, the user data, and the crowd-sourced historical data. In embodiments and as described with FIG. 2, the user device 218 may be easily accessible by the user (e.g., the user device 218 can be a smartphone) as the user moves throughout the rides and events of the amusement park.

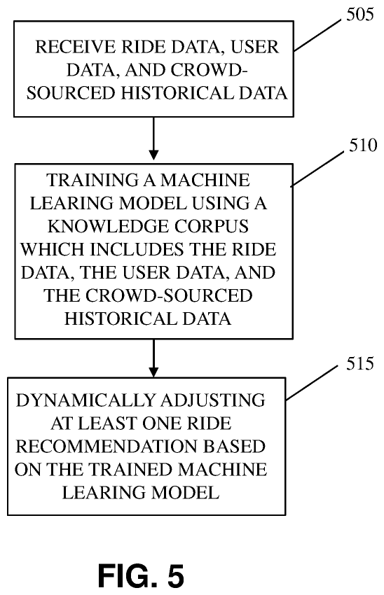

FIG. 5 shows a flowchart of an exemplary method in accordance with aspects of the present invention. Steps of the method may be carried out in the environment of FIG. 2 and are described with reference to elements depicted in FIG. 2.

In embodiments, at step 505, the system receives, at a machine learning (ML) module 214, ride data, user data, and crowd-sourced historical data. In embodiments and as described with FIG. 2, the ride data includes information about a type of ride, how the ride is moving, the seat arrangements and ergonomics of the ride, the availability of the ride, restrictions of the ride, and precautions of the ride and the user data includes user information and other user data.

In embodiments, at step 510, the system trains, at the ML module 214, a machine learning model using a knowledge corpus which includes the ride data, the user data, and the crowd-sourced historical data. In embodiments and as described with FIG. 2, the machine learning model is iteratively trained by the knowledge corpus as the knowledge corpus is received and updated.

In embodiments, at step 515, the system dynamically adjusts, at the ML model 214, at least one ride recommendation based on the trained machine learning model in real-time. In embodiments and as described with FIG. 2, the ML model 214 sends the dynamically adjusted at least one recommendation to the ride recommender module 212 for adjusting at least one future recommendation provided by the ride recommender 212.

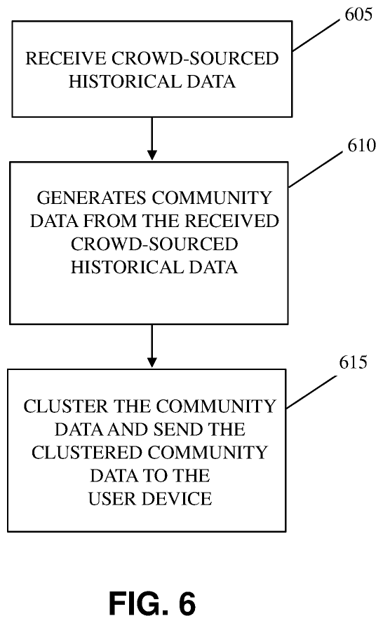

FIG. 6 shows a flowchart of an exemplary method in accordance with aspects of the present invention. Steps of the method may be carried out in the environment of FIG. 2 and are described with reference to elements depicted in FIG. 2.

In embodiments, at step 605, the system receives, at a machine learning (ML) module 214, crowd-sourced historical data from the user device 218. In embodiments, at step 610, the system generates, at the ML module 214, community data from the received crowd-sourced historical data. In embodiments and as described with FIG. 2, the community data includes information from a plurality users of a community which are correlated by different factors such as type of amusement park rides, genre of amusement park rides, thrill rides, water events, sport events, environmental factors, user profiling, health profiles, and user motives.

In embodiments, at step 615, the system clusters, at the ML module 214, the community data by common factors using a k-means clustering algorithm of a machine learning model and sends the clustered community data to the user device 218. In embodiments and as described with FIG. 2, the ML module 214 sends the clustered community data to the user device 218 through the cloud-based system 215. In embodiments, the user is able to gain insight and knowledge about the rides and events of the amusement park through the user device 218.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by the processor set, ride data, user data which comprises user information and other user data, and crowd-sourced historical data;
training, by the processor set, a machine learning model using a knowledge corpus which includes the ride data, the user data, and the crowd-sourced historical data; and
dynamically adjusting, by the processor set, at least one ride recommendation based on the trained machine learning model.

2. The computer-implemented method of claim 1, wherein the dynamically adjusting the at least one ride recommendation is performed in real-time.

3. The computer-implemented method of claim 1, wherein the user information is selected from the group consisting of ergonomic preferences, health conditions, and medical conditions of a user.

4. The computer-implemented method of claim 1, wherein the other user data is selected from the group consisting of medications, eating habits and food consumed, and current clothing of a user.

5. The computer-implemented method of claim 1, further comprising generating community data from the crowd-sourced historical data.

6. The computer-implemented method of claim 5, further comprising clustering the generated community data using a k-means clustering algorithm of the machine learning model.

7. The computer-implemented method of claim 6, further comprising sending the clustered community data to a user device of a user.

8. The computer-implemented method of claim 1, further comprising sending the dynamically adjusted at least one ride recommendation to a user device of a user.

9. The computer-implemented method of claim 1, further comprising sending the dynamically adjusted at least one ride recommendation to an output display in an amusement park.

10. The computer-implemented method of claim 1, wherein the machine learning model is trained using the knowledge corpus and a reinforcement learning algorithm.

11. The computer-implemented method of claim 1, wherein the ride data is selected from the group consisting of a type of ride, how the ride is moving, seat arrangements and ergonomics of the ride, the availability of the ride, restrictions of the ride, and precautions of the ride.

12. A computer program product comprising one or more computer readable storage media having program instructions collectively stored on the one or more computer readable storage media, the program instructions executable to:
receive crowd-sourced historical data;
generate community data from the received crowd-sourced historical data;
cluster the generated community data using a k-means clustering algorithm of a machine learning model; and
send the clustered community data to a user device of a user.

13. The computer program product of claim 12, wherein the crowd-sourced historical data comprises at least one phobia.

14. The computer program product of claim 13, wherein the at least one phobia is selected from the group consisting of a user which is scared of heights, a user which is scared of free falls, a user which is scared of water, and a user which is scared of motion sickness.

15. The computer program product of claim 12, further comprising receiving ride data and user data which comprises user information and other user data.

16. The computer program product of claim 15, further comprising training the machine learning model using a knowledge corpus which includes the ride data, the user data, and the crowd-sourced historical data.

17. The computer program product of claim 16, further comprising dynamically adjusting at least one ride recommendation based on the trained machine learning model.

18. The computer program product of claim 17, wherein the machine learning model is trained using the knowledge corpus and a reinforcement learning algorithm.

19. The computer program product of claim 18, further comprising sending the dynamically adjusted at least one ride recommendation to the user device of the user

20. A system comprising:
a processor set, one or more computer readable storage media, and program instructions collectively stored on the one or more computer readable storage media, the program instructions executable to:
receive ride data, user data which comprises user information and other user data, and crowd-sourced historical data;
train a machine learning model using a knowledge corpus which includes the ride data, the user data, and the crowd-sourced historical data; and
dynamically adjust at least one ride recommendation based on the trained machine learning model,
wherein the machine learning model is trained using the knowledge corpus using a reinforcement learning algorithm.
